(19) United States
(12) Patent Application Publication
(10) Pub. No.: US 2006/0023802 A1
(43) Pub. Date: Feb. 2, 2006

(54) Concatenated coding of the multi-band orthogonal frequency division modulation system

(75) Inventors: Jaiganesh Balakrishnan, Bangalore (IN); Srinivas Lingam, Richardson, TX (US); Manish Goel, Plano, TX (US); Anuj Batra, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/190,455

(22) Filed: Jul. 27, 2005

Related U.S. Application Data
(60) Provisional application No. 60/592,305, filed on Jul. 28, 2004.

(51) Int. Cl. H04L 23/02; H04K 1/10; H04L 27/04

(52) U.S. Cl. 375/265; 375/260; 375/295

(57) ABSTRACT

The present disclosure is directed to a transmitter 200 that includes a first block encoder 450 operable to block encode at least a first portion of a multi-band orthogonal frequency division modulation signal. The transmitter 200 also includes a convolution encoder 304 operable to convolution encode the output of the first block encoder 450. A method of communicating is also disclosed. The method comprises block encoding a first portion of a message to produce a first outer code word. The method includes convolution encoding the first outer code word to produce a first inner code word. The method also includes transmitting the first inner code word as part of a multi-band orthogonal frequency division modulation signal.

### CROSS-REFERENCE TO RELATED APPLICATIONS

This application claims priority to U.S. Provisional Application No. 60/592,305 filed Jul. 28, 2004, entitled “Concatenated coding of the multi-band OFDM system,” by Jaiganesh Balakrishnan, et al, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to communications, and more particularly, but not by way of limitation, to concatenated coding of the multi-band orthogonal frequency division modulation system.

### BACKGROUND OF THE INVENTION

A network provides for communication among members of the network. Wireless networks allow connectionless communications. Wireless local area networks are generally tailored for use by computers and may employ sophisticated protocols to promote communications. Wireless personal area networks with ranges of about 10 meters are poised for growth, and increasing engineering development effort is committed to developing protocols supporting wireless personal area networks.

With limited range, wireless personal area networks may have fewer members and require less power than wireless local area networks. The IEEE (Institute of Electrical and Electronics Engineers) is developing the IEEE 802.15.3a wireless personal area network standard. The term piconet refers to a wireless personal area network having an ad hoc topology comprising communicating devices. The piconet may be coordinated by a piconet coordinator (PNC). Piconets may form, reform, and abate spontaneously as various wireless devices enter and leave each other's proximity. Piconets may be characterized by their limited temporal and spatial extent. Physically adjacent wireless devices may group themselves into multiple piconets running simultaneously.

One proposal to the IEEE 802.15.3a task group divides the 7.5 GHz ultra wide band (UWB) bandwidth from 3.1 GHz to 10.6 GHz into fourteen bands, where each band is 528 MHz wide. These fourteen bands are organized into four band groups each having three 528 MHz bands and one band group of two 528 MHz bands. An example piconet may transmit a first multi-band orthogonal frequency division modulation (MB-OFDM) symbol in a first 312.5 nS duration time interval in a first frequency band of a band group, a second MB-OFDM symbol in a second 312.5 nS duration time interval in a second frequency band of the band group, and a third MB-OFDM symbol in a third 312.5 nS duration time interval in a third frequency band of the band group. Other piconets may also transmit concurrently using the same band group, discriminating themselves by using different time-frequency codes and a distinguishing preamble sequence. This method of piconets sharing a band group by transmitting on each of the three 528 MHz wide frequencies of the band group may be referred to as time frequency coding or time frequency interleaving (TFI). Alternately, piconets may transmit exclusively on one frequency band of the band group which may be referred to as fixed frequency interleaving (FFI). Piconets employing fixed frequency interleaving may distinguish themselves from other piconets employing time frequency interleaving by using a distinguishing preamble sequence. In practice four distinct preamble sequences may be allocated for time frequency interleaving identification purposes and three distinct preamble sequences may be allocated for fixed frequency interleaving. In different piconets different time-frequency codes may be used. In addition, different piconets may use different preamble sequences.

The structure of a message packet according to the Multi-band OFDM SIG physical layer specification comprises a preamble field, a header field, and a payload field. The preamble field may contain multiple instances of the distinct preamble sequence. The preamble field may be subdivided into a packet and frame detection sequence and a channel estimation sequence. The channel estimation sequence is a known sequence that may be used by a receiver to estimate the characteristics of the wireless communication channel to effectively compensate for adverse channel conditions. The preamble field, the header field, and the payload field may each be subdivided into a plurality of OFDM symbols.

### SUMMARY OF THE INVENTION

According to one embodiment, a transmitter is provided. The transmitter includes a first block encoder operable to block encode at least a first portion of a multi-band orthogonal frequency division modulation signal. The transmitter also includes a convolution encoder operable to convolution encode the output of the first block encoder.

In another embodiment, a method of communicating is also disclosed. The method comprises producing a first outer code word by block encoding a first portion of a message. The method includes producing a first inner code word by convolution encoding the first outer code word. The method also includes transmitting the first inner code word as part of a multi-band orthogonal frequency division modulation signal.

In another embodiment, a transceiver is provided. The transceiver includes a transmitter that includes a first block encoder operable to block encode at least a first portion of a multi-band orthogonal frequency division modulation signal and a convolution encoder operable to convolution encode the output of the first block encoder. The transceiver also includes a receiver that has a decoder operable to decode the multi-band orthogonal frequency division modulation signal.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 depicts an exemplary wireless piconet for implementing an embodiment of the present disclosure.

FIG. 2 is a block diagram of a transmitter in communication with a receiver according to an embodiment of the present disclosure.

FIG. 3A and FIG. 3B depict an encoder and decoder, respectively, according to an embodiment of the present disclosure.

FIG. 4 depicts the structure of a physical layer convergence protocol (PLCP) header according to an embodiment of the present disclosure.

FIG. 5 depicts the structure of a PHY header according to an embodiment of the present disclosure.

FIG. 6A and FIG. 6B depict an encoder and decoder, respectively, according to an embodiment of the present disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

Block coding and convolution coding are forward error correction coding techniques that add redundancy to subject information to promote reception of a transmitted signal bearing the subject information. Block coding may provide an alternative to convolution coding and may be preferred to convolution coding in some communication environments. In other communication environments, block coding may be combined with convolutional coding, for example, Reed-Solomon codes may be concatenated with convolutional codes as an outer code to provide additional coding gain. In block coding, a block of input information bits may be processed to produce a block of output information bits. The number of output bits is greater than the number of input information bits because of the redundancy introduced during the block encoding process. The ratio of input to output information bits may be referred to as the coding rate. For example, when 200 input bits are convolution encoded to produce 600 output bits, the coding rate is ⅓.

In block coding, messages are comprised of a sequence of complete blocks. Receivers may be required to receive a complete block of output information bits, for example 2400 bits, before decoding, which may produce a delay that is referred to as decoding latency. When the number of input information bits does not fill the last block, the last block may be filled by pad bits that carry no meaningful information. However, instead of just filling the last block with pad bits, a repetition of some of the information bits, parity bits, or combination of information and parity bits may be used which may improve the signal to noise ratio of some of the bits at the receiver and produce improved performance. Longer block sizes provide more usable redundancy and are associated with greater coding gain or the ability to receive the transmitted message at a receiver. At the same time, longer block sizes lead to greater decoding latency. Additionally, longer block sizes lead to the use of more pad bits which constitute an overhead burden on the communications throughput rate. On average, the number of pad bits employed per message may be expected to be half of the block size. Using shorter block sizes reduces overhead associated with pad bits and reduces decoding latency. Shorter block sizes also have less coding gain.

The present disclosure teaches the concatenation of block coding and convolutional coding in a multi-band orthogonal frequency division modulation (MB-OFDM) system using a (23, 17) Reed-Solomon code defined on a Galois (256) field that ensures that the physical layer convergence protocol header, after Reed-Solomon outer block coding and convolutional inner block coding, fits into an integral multiple of the periodicity of the time-frequency code. Also taught is a physical convergence layer protocol (PLCP) header that employs tail bits between a block consisting of a PHY header, media access control (MAC) header, and header check sequence (HCS) and the block of Reed-Solomon parity bits. The present disclosure teaches receiver implementations to omit the Reed-Solomon decoder and to employ a convolutional decoder alone. Also taught is the use of a bit in the PHY header to indicate the optional use of concatenation of block coding and convolutional coding for a payload. In other embodiments, instead of using a bit to indicate the use of concatenated code, new rates may also be defined and that information may be embedded into the rate field. A bit may also be needed to indicate the use of a block code for payload, such as LDPC.

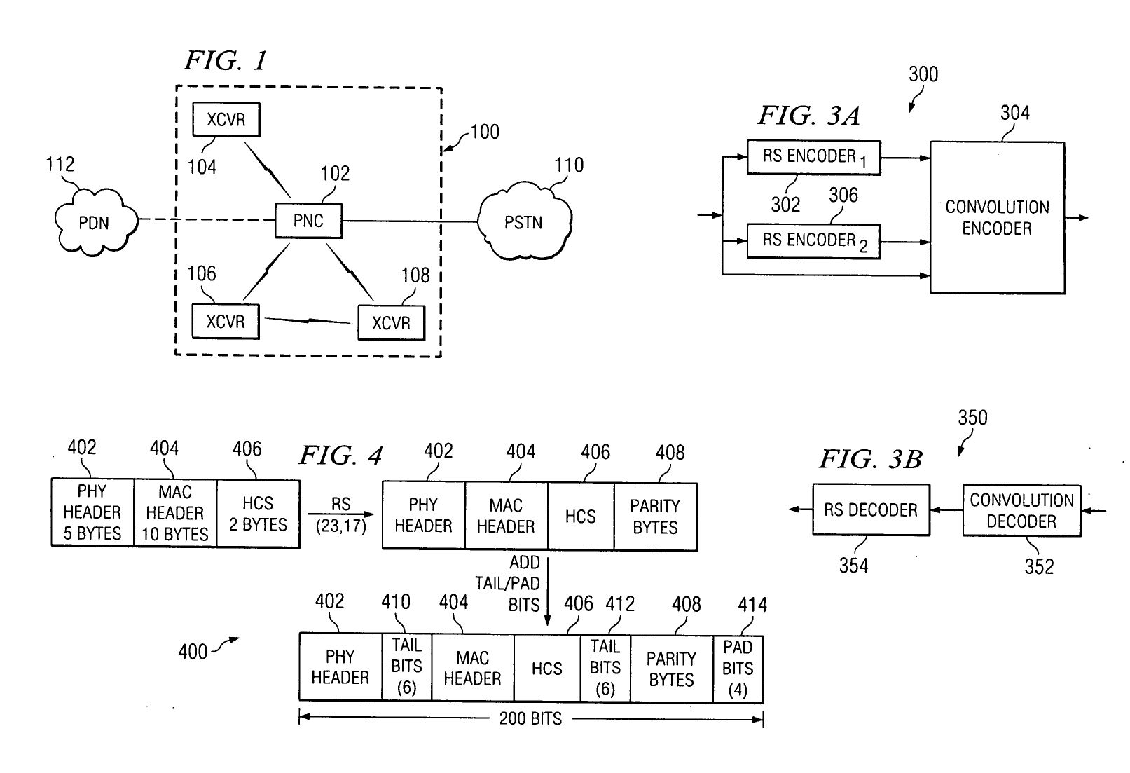

Turning now to FIG. 1, a block diagram depicts a piconet 100 formed by a number of cooperating electronic devices. A first transceiver 102 operates as the piconet controller for the piconet 100. A second transceiver 104, a third transceiver 106, and a fourth transceiver 108 operate as member of the piconet 100. The transceivers 102, 104, 106, and/or 108 may also be capable of operating as the piconet controller of the piconet 100, but are not depicted as carrying out that role. The first transceiver 102 may broadcast beacon messages, which may be referred to simply as beacons, to promote communication among the members of the piconet 100. The effective range of the beacon messages, and hence the effective boundary of the piconet 100, is depicted by a dashed line in FIG. 1. The first transceiver 102 may be connected to either a public switched telephone network 110 or to a public switched data network 112 whereby the members of the piconet 100, for example the transceivers 102, 104, 106, and 108, may communicate with the Internet or other network of interconnected communication devices. The transceivers 102, 104, 106, and 108 may wirelessly communicate according to the Multi-band orthogonal frequency division modulation Alliance (MBOA) Special Interest Group (SIG) Physical layer specification, according to a WiMedia wireless personal area network protocol, and/or according to an Ecma wireless personal area network protocol. The MBOA SIG Physical layer specification is incorporated herein by reference for all purposes. The wireless communications within the piconet 100 are transmitted and received as a sequence of orthogonal frequency division modulation (OFDM) symbols. While the description above focuses on a wireless multi-band OFDM system, one skilled in the art will readily appreciate that the dual block size block coding concept may be applied to other OFDM systems. Further, the transceivers 102, 104, 106, and 108 may be operable for implementing the present disclosure.

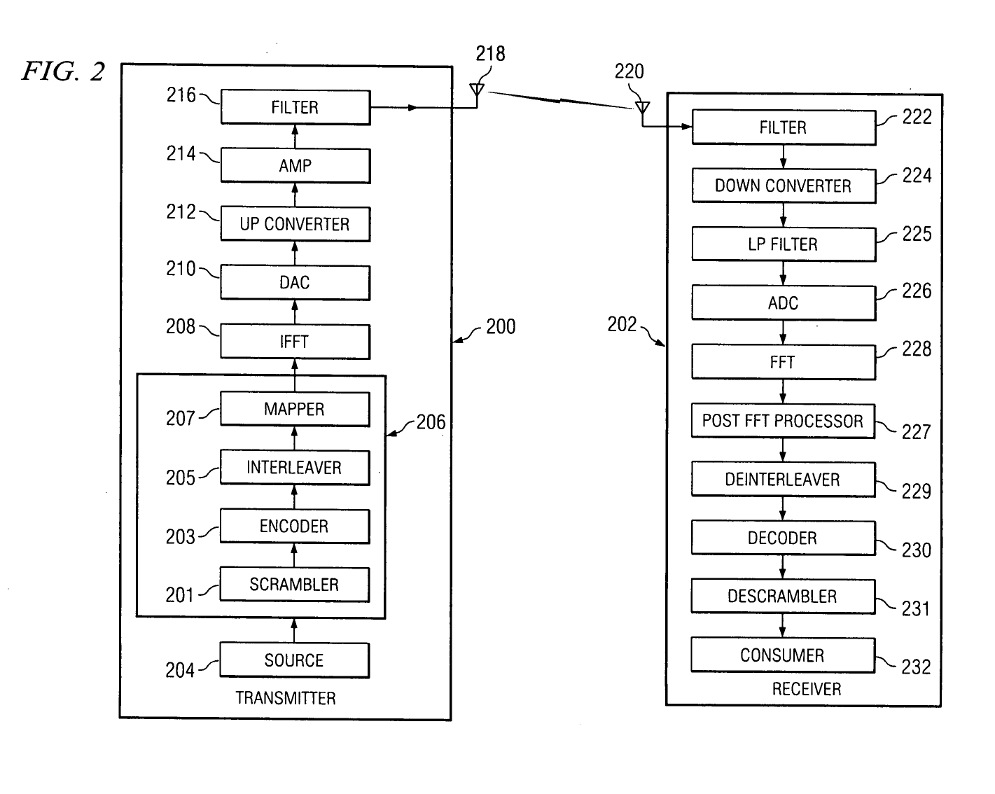

Turning now to FIG. 2, a wireless transmitter 200 is shown in communication with a wireless receiver 202. Some conventional elements of transmitters and receivers may be omitted from FIG. 2 but will be readily apparent to one skilled in the art. The wireless transmitter 200 is suitable for transmitting OFDM symbols formatted according to embodiments of the present disclosure, and the wireless receiver 202 is suitable for receiving the OFDM symbols formatted according to embodiments of the present disclosure. A signal source 204 provides data to be transmitted to a modulator 206. The modulator 206 may comprise a spreader or scrambler component 201, an encoder 203, an interleaver 205, and a mapper 207. The scrambler component 201 processes the data, which may be referred to as a bit stream, and provides input information data to the encoder 203. The encoder 203 encodes the input information data into output information data. An interleaver 205 may further process the bit stream. The output of the interleaver 205 is provided to a mapper 207 that mounts the output of the interleaver onto quadrature amplitude modulation (QAM) constellations for each of the tones. The modulator 206 provides the tones to an inverse fast Fourier transformer component 208 which translates the frequency domain representation of the data into a time domain representation of the same data.

The inverse fast Fourier transformer component 208 provides the time domain representation of the signal to a digital-to-analog converter 210 which converts the digital representation of the signal to an analog form. The analog form of the signal is a 528 MHz wide baseband signal. The digital-to-analog converter 210 provides the 528 MHz wide baseband signal to an up converter 212 which frequency shifts the 528 MHz wide baseband signal to the appropriate frequency band for transmission. The up converter 212 provides the up converted 528 MHz wide signal to an amplifier 214 which boosts the signal strength for wireless transmission. The amplifier 214 feeds the up converted, amplified, 528 MHz wide signal to a band-select filter 216, typically having a bandwidth of 1584 MHz, that attenuates any spurious frequency content of the up converted signal which lies outside the desirable three bands of the MB-OFDM signal. The band-select filter 216 feeds a transmitting antenna 218 which wirelessly transmits the up converted, amplified, band-select filtered 528 MHz wide signal.

The wireless signal is received by a receiving antenna 220. The receiving antenna 220 feeds the signal to a receiving band-select filter 222, typically having a bandwidth of 1584 MHz, that selects all three bands of the MB-OFDM signal from the entire bandwidth which the receiving antenna 220 is capable of receiving. The receiving band-select filter 222 feeds the selected MB-OFDM signal to a down converter 224 which frequency shifts the MB-OFDM signal to a 528 MHz baseband signal. The down converter 224 feeds the 528 MHz baseband signal to a base-band, low-pass filter 225, typically having a 528 MHz bandwidth. The base-band, low-pass filter 225 feeds the filtered 528 MHz baseband signal to an analog to digital converter 226 which digitizes the filtered 528 MHz baseband signal. The analog to digital converter 226 feeds the digitized 528 MHz baseband signal to a fast Fourier transformer 228 which converts the digitized 528 MHz baseband signal from the time domain to the frequency domain, decomposing the digitized 528 MHz baseband signal into distinct frequency domain tones. The fast Fourier transformer 228 feeds the frequency domain tones to a post FFT processing block 227 that performs frequency domain equalization to compensate for the multi-path channel, phase tracking and correction and also the demapping. The post FFT processing block 227 output feeds to a deinterleaver 229 that reverses the processing performed in the transmitter 200 by the interleaver 205. The deinterleaver 229 output feeds to a decoder component 230 that extracts the data from the blocks. The decoder component 230 output feeds to a descrambler component 231 which reverses the processing performed in the transmitter 200 by the scrambler component 201. The stream of data is then provided to a medium access control (MAC) component 232 which interprets and uses the stream of data.

The wireless transmitter 200 and wireless receiver 202 structures described above may be combined in some embodiments in a single device referred to as a transceiver, for example the transceivers 102, 104, 106, and 108 described above with reference to FIG. 1. While the transmitting bandpass filter 216 and the amplifier.214 are described as separate components, in some embodiments these functions may be integrated in a single component. Additionally, in some embodiments the up converted 528 MHz bandwidth signal may be bandpass filtered by the transmitting bandpass filter 216 before it is amplified by the amplifier 214. Other systems, components, and techniques may be implemented for these purposes which will readily suggest themselves to one skilled in the art and are all within the spirit and scope of the present disclosure.

MB-OFDM messages may be partitioned into a preamble portion, a header portion and a payload portion. The header provides information about how to receive the MB-OFDM message, for example identifying a data rate, a message length, and other message parameters. In the future, concatenated coding or block coding may be employed to improve reception of the payload. To support backwards compatibility among MB-OFDM transceivers 106, 108, 104, it is preferred that the transmission of headers not change materially in the future. Additionally, it is preferred that the transmission of the header be more robust than the transmission of the payload, because of the role of the header in defining transmission parameters for the receiver 202. These considerations suggest that robust concatenated coding be employed in MB-OFDM message headers upon the first deployment of MB-OFDM systems.

Turning to FIG. 3A, an exemplary concatenated encoder 300 is depicted. In an embodiment, the concatenated encoder 300 may be employed in the role of the encoder 203 depicted in FIG. 2 above. The concatenated encoder 300 comprises a first Reed-Solomon encoder 302 and a convolutional encoder 304. After the MAC (media access control) header and HSC (header check sequence) portions, both of which will be described in greater detail hereinafter, are output from the scrambler 201, the unscrambled PHY header and scrambled MAC plus HSC are sent to the first Reed-Solomon encoder 302. The first Reed-Solomon encoder 302 block encodes the PLCP header, which may also be referred to as an outer code, and outputs the PLCP header block to the convolutional encoder 304 for convolutional encoding. The convolutional encoder 304 then outputs the concatenation coded PLCP header to, for example, the interleaver 206. The first Reed-Solomon encoder 302 adds redundancy to the PLCP header in the form of Reed-Solomon parity bits and thereby increases the ability of the receiver 202 to receive the PLCP header portion of the MB-OFDM message.

In an embodiment, a payload portion of the MB-OFDM message is output from the scrambler 201 to the convolutional encoder 304 for convolutional encoding. The convolutional encoder 304 outputs the convolutional encoded payload to the interleaver 206. Note that in this embodiment the payload is not encoded using concatenated encoding. In an alternative embodiment, the payload portion of the MB-OFDM message is output from the scrambler 201 to a second Reed-Solomon encoder 306. The second Reed-Solomon encoder 306 block encodes the payload, which may also be referred to as an outer code, and outputs the payload block or blocks to the convolutional encoder 304 for convolutional encoding. The convolutional encoder 304 then outputs the concatenation coded payload to, for example, the interleaver 206. The second Reed-Solomon encoder 306 adds redundancy to each block of the payload in the form of Reed-Solomon parity bits and thereby increases the ability of the receiver 202 to receive the payload portion of the MB-OFDM message. In an embodiment, the first Reed-Solomon encoder 302 employs a (23, 17) Reed-Solomon code defined on a Galois field (256) and the second Reed-Solomon encoder 306 employs a (255, 239) Reed-Solomon code defined on a Galois field (256). In some embodiments, if the constraint of reusing the Reed-Solomon decoder for the header and payload is removed, a different Reed-Solomon code for the header encoding can be defined. For example, a (23, 17) Reed-Solomon code obtained by shortening a (31, 25) Reed-Solomon code defined over a Galois field (32) can be used.

In other embodiments, only one encoder may be needed instead of both the first and second Reed-Solomon encoders 302 and 306. Since the necessary functionality is based on the same native or mother code, the same logic may be used to code both the header and payload. The header would be encoded by using 232 zero bytes at the end of the code word and then running logic to produce the parity bytes.

Turning now to FIG. 3B, an exemplary concatenated decoder 350 is depicted. In an embodiment, the concatenated decoder 350 may be employed in the role of the decoder 230 depicted in FIG. 2 above. The concatenated decoder 350 comprises a convolutional decoder 352 and a Reed-Solomon decoder 354. The convolutional decoder 352 decodes the inner code of the PLCP header and outputs the outer code of the PLCP header to the Reed-Solomon decoder 354. The Reed-Solomon decoder 354 decodes the outer code of the PLCP header and outputs the MAC (media access control) header and HSC (header check sequence) portions to the descrambler 231. In an embodiment, the payload portion of the MB-OFDM message is decoded by the convolutional decoder and is passed through the Reed-Solomon decoder 354 without processing or bypasses the Reed-Solomon decoder 354 and is output to the descrambler 231. In an alternate embodiment, wherein the payload is also block encoded with a Reed-Solomon code, for example by the second Reed-Solomon encoder 306, the outer code of the payload is decoded by the Reed-Solomon decoder 354.

Because the PLCP header and payload are encoded using Reed-Solomon codes defined on the same Galois field (256), the Reed-Solomon decoder 354 may be employed for decoding both the PLCP header and the payload. More particularly, decoding the Reed-Solomon outer code involves processing the MB-OFDM message portions using roots of the subject Reed-Solomon codes. The Let α be a root of the primitive polynomial
p(x)=x⁸+x⁴+x³+x²+1 (1)
associated with Galois field (GF) (256). The generator polynomial for the (255, 239) Reed-Solomon code defined on GF(256) is given by:

$${g}_{1} ( x ) = {\prod }_{i = 1}^{16} ( x - {α}^{i} ) \qquad ( 2 )$$

The generator polynomial for the (23, 17) Reed-Solomon code defined on GF(256) is

$${g}_{2} ( x ) = {\prod }_{i = 1}^{6} ( x - {α}^{i} ) \qquad ( 3 )$$

which is a subset of the generator polynomial for the (255, 239) Reed-Solomon code defined on GF(256) defined by equation (2). The (23, 17) Reed-Solomon code defined on GF(256) has roots that are a sub-set of the roots of the (255, 239) Reed-Solomon code defined on GF(256), which allows the Reed-Solomon encoder, such as encoders 302 and/or 306, and decoder 354 to be reused.

Turning now to FIG. 4, the construction of a PLCP header 400 according to an embodiment of the present disclosure is depicted. The PLCP header 400 comprises a PHY header 402 containing 5 bytes, a MAC header 404 containing 10 bytes, and a header check sequence (HCS) 406 containing 2 bytes. After the PHY header 402, the MAC header 404, and the HCS 406 are block encoded using the (23, 17) Reed-Solomon code. In the preferred embodiment, the MAC header 404 and HCS 406 are scrambled. Reed-Solomon parity bytes 408 containing 6 bytes are produced and appended to the end of the header. A first block of tail bits 410 containing six bits is placed between the PHY header 402 and the scrambled MAC header 404. A second block of tail bits 412 containing six bits is placed between the scrambled HCS 406 and the Reed-Solomon parity bytes 408. A block of pad bits 414 containing four bits is placed at the end of the header. The tail bits 410, 412 and the pad bits 414 are zero valued and may be employed by the convolutional decoder 352 to terminate a trellis structure, for example a Viterbi decoder, to a known state, thereby delimiting between header fields. A receiver 202 which does not employ the Reed-Solomon decoder 354 may discard the parity bytes and the pad bits and extract the message portion, namely the PHY header, MAC header and HCS. This is possible due to the systematic nature of the Reed-Solomon outer code, but comes at the cost of loss of coding gain while decoding the PLCP header.

The PLCP header 400 is 200 bits long. After convolutional encoding, the PLCP header 400 grows to 600 bits, based on ⅓ rate convolutional encoding. At a 53.33×17/23=39.4 MHz data rate, the data rate planned to be used for transmitting the PLCP header 400, the PLCP header 400 consumes twelve MB-OFDM symbols. The periodicity of the time-frequency code in the MB-OFDM system is six symbols. The structure of the PLCP header 400 described avoids the need to add pad bits to complete an otherwise partial six symbol block, thereby avoiding increasing overhead. The structure of the PLCP header 400 described above keeps latency to a minimum, which is desirable as decoding of the PLCP header 400 should be very quick. Analysis indicates that the PLCP header 400 described above is distinctly more robust than the payload block encoded with the (255, 239) Reed-Solomon code defined on the GF(256) described above.

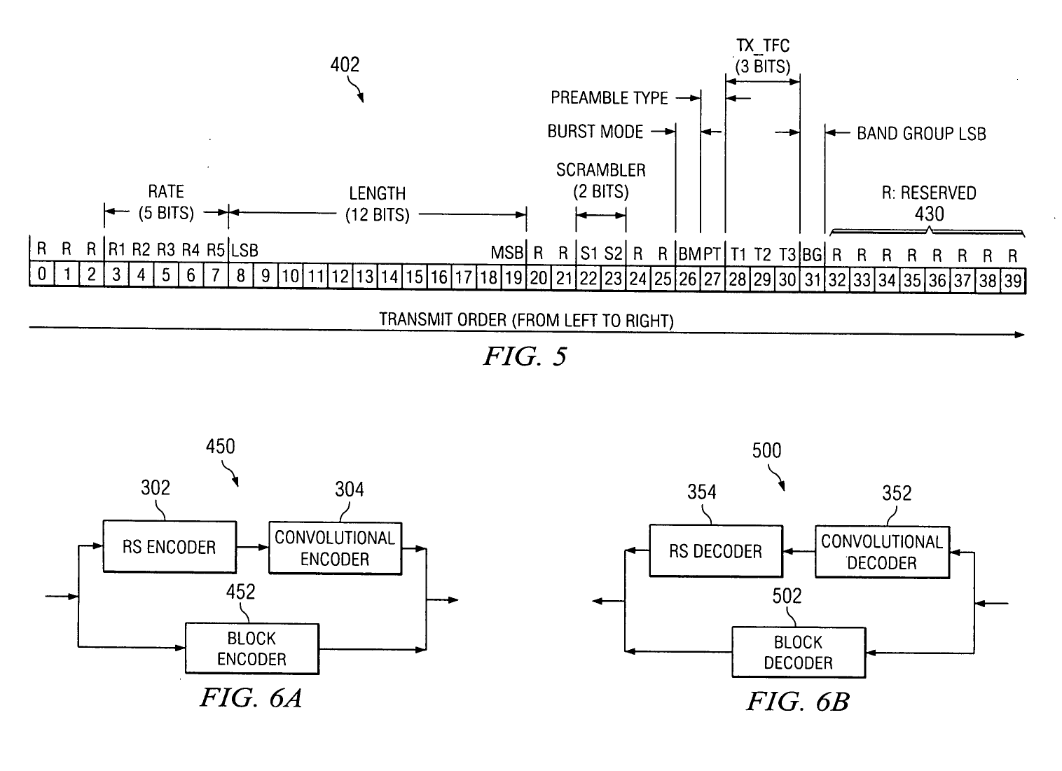

Turning now to FIG. 5, the PHY header 402 is depicted. In an embodiment, a bit in the PHY header 402 may be employed to indicate whether optional Reed-Solomon encoding of the payload portion of the MB-OFDM message is employed, for example one of the reserved bits 430 of the PHY header 402. In other embodiments instead of a bit in the PHY header 402, concatenated coding of payload may also be embedded into the RATE field. For further details on the structure of the PHY header as currently defined, refer to the MBOA SIG Physical layer specification.

Turning now to FIG. 6A, an alternative embodiment of an encoder 450 is depicted. The encoder 450 is substantially similar to the concatenated encoder 300 and includes the first Reed-Solomon encoder 302 and the convolutional encoder 304. The encoder 450 is distinguished by excluding the second Reed-Solomon encoder 306, which is optional in the concatenated encoder 300, and by the inclusion of the block encoder 452. The block encoder 452 is employed to encode the payload. In this embodiment, the payload is not concatenated encoded and is not processed by the convolutional encoder. In this embodiment, the block encoder 452 may be one of several known turbo codes or may be a low density parity check code.

Turning now to FIG. 6B, an alternate embodiment of a decoder 500 is depicted. The decoder 500 is substantially similar to the concatenated decoder 350 and includes the convolutional decoder 352 and the Reed-Solomon decoder 354 The decoder 500 is distinguished by the inclusion of a block decoder 502. The block decoder 502 decodes the payload portion of the MB-OFDM message. The block decoder 502 decodes using a turbo decoder or the low density parity check decoder.

The several embodiments described above may be implemented as a system on an integrated circuit chip. Alternatively, the embodiments may be implemented as a plurality of integrated circuit chips and/or analog components that are coupled together.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A transmitter, comprising:
a first block encoder operable to block encode at least a first portion of a multi-band orthogonal frequency division modulation signal; and
a convolution encoder operable to convolution encode the output of the first block encoder.

2. The transmitter of claim 1, wherein the first block encoder employs a (23, 17) Reed-Solomon code defined over a Galois field (256).

3. The transmitter of claim 2, wherein the (23, 17) Reed-Solomon code is obtained by shortening a (31, 25) Reed-Solomon code defined over a Galois field (32).

4. The transmitter of claim 2, wherein the (23, 17) Reed-Solomon code is obtained by shortening a (255, 249) Reed-Solomon code defined over a Galois field (256).

5. The transmitter of claim 2, wherein the roots of the (23, 17) Reed-Solomon code are included among the roots of a (255, 239) Reed-Solomon code defined over a Galois field (256).

6. The transmitter of claim 1, wherein the first block encoder employs a Reed-Solomon code selected to ensure that the total number of encoded bits of a physical layer convergence protocol header output by the convolution encoder is an integer multiple of a periodicity of a time-frequency code of the multi-band orthogonal frequency division modulation signal.

7. The transmitter of claim 1, wherein the first block encoder encodes a physical layer convergence protocol header, the physical layer convergence protocol header including a first block of tail bits to delimit a PHY header portion from a media access control header portion of the physical layer convergence protocol header and a second block of tail bits to delimit a header check sequence portion from a parity bytes portion of the physical layer convergence protocol header.

8. The transmitter of claim 1, wherein the first block encoder encodes a portion of the physical layer convergence protocol header, the physical layer convergence protocol header comprises a PHY header of 40 information bits, a tail bit field of 6 zero bits, a scrambled media access control header plus header check sequence field of 96 information bits, a tail bit field of 6 zero bits, a Reed-Solomon parity field of 48 parity bits, and a tail bit field of 4 zero bits.

9. The transmitter of claim 1, further including:
a second block encoder operable to block encode a second portion of the bit stream for the multi-band orthogonal frequency division modulation signal, wherein the second block encoder employs a (255, 239) Reed-Solomon code defined over a Galois field (256).

10. The transmitter of claim 1, wherein the first block encoder is operable to encode one of a Rate field and a physical layer convergence protocol header, the physical layer convergence protocol header including a PHY header portion, a bit in the PHY header portion indicating the optional use of block encoding for a payload portion of the multi-band orthogonal frequency division modulation signal.

11. A method of communicating, comprising:
producing a first outer code word by block encoding a first portion of a message;
producing a first inner code word by convolution encoding the first outer code word; and
transmitting the first inner code word as part of a multi-band orthogonal frequency division modulation signal.

12. The method of claim 11, wherein block encoding employs a Reed-Solomon code selected to ensure that the total number of encoded bits of a physical layer convergence protocol header produced by the convolution encoding is an integer multiple of six multi-band orthogonal frequency division modulation symbols.

13. The method of claim 12, wherein the physical layer convergence protocol header is twelve multi-band orthogonal frequency division modulation symbols.

14. The method of claim 11, wherein the first portion of the message is a physical layer convergence protocol header and further including:
block encoding a payload portion of the message, thereby producing a plurality of outer code words, wherein the block encoding the payload employs a (255, 239) Reed-Solomon code defined over a Galois field (256).

15. The method of claim 11, further including:
discarding a block code parity portion of the first outer code word at a receiver, the receiver receiving the multi-band orthogonal frequency division modulation signal.

16. A transceiver, comprising:
a transmitter including:
a first block encoder operable to block encode at least a first portion of a multi-band orthogonal frequency division modulation signal, and
a convolution encoder operable to convolution encode the output of the first block encoder;
and
a receiver including:
a decoder operable to decode the multi-band orthogonal frequency division modulated signal.

17. The transmitter of claim 16, wherein the first block encoder encodes a physical layer convergence protocol header using a (23, 17) Reed-Solomon code.

18. The transmitter of claim 16, further including a second block encoder operable to encode a payload portion of the multi-band orthogonal frequency division modulated signal using a (255, 239) Reed-Solomon code and wherein the convolution encoder is further operable to convolution encode the output of the second block encoder.

19. The transmitter of claim 16, wherein the decoder comprises:
a convolution decoder operable to decode convolutionally the multi-band orthogonal frequency division modulation signal; and
a block decoder operable to-decode the first portion of the multi-band orthogonal frequency division modulation signal.

20. The transmitter of claim 19, further including a second block encoder operable to encode a payload portion of the multi-band orthogonal frequency division modulation signal using a (255, 239) Reed-Solomon code, wherein the convolution encoder is further operable to convolution encode the output of the second block encoder, and wherein the block decoder is further operable to decode the payload portion.

21. The transmitter of claim 19, wherein block decoder decodes the payload portion based on a bit selecting optional payload block encoding, the bit contained in the first portion of the multi-band orthogonal frequency division modulation signal.

22. The transmitter of claim 16, further including:
a second block encoder operable to block encode a payload portion of the multi-band orthogonal frequency division modulation signal using a block code selected from the group consisting of turbo codes and low density parity check code.

23. A transmitter, comprising:
a block encoder operable using a Reed-Solomon (23, 17) to encode at least a portion of a multi-band orthogonal frequency division modulation signal including a physical layer convergence protocol header comprising a PHY (physical layer) header having 5-bytes, a MAC (media access control) header having 10-bytes, a HCS (header check sequence) having 2-bytes, the MAC header and HCS bytes being scrambled, to produce 6 Reed-Solomon Parity bytes, the physical layer convergence protocol header further comprising 6 tail bits provided after the PHY header, 6 tail bits provided after the scrambled MAC header and HCS, and 4 tail bits after the Reed-Solomon Parity Bytes; and
a convolution encoder operable on the PHY header, 6 tail bits provided after the PHY header, scrambled MAC header and HCS, 6 tails bits provided after the scrambled MAC header and HCS, 6 Reed-Solomon Parity bytes, and 4 tail bits at a coding rate of about ⅓.
